(19) United States
(12) Patent Application Publication
(10) Pub. No.: US 2026/0035009 A1
(43) Pub. Date: Feb. 5, 2026

(54) Vehicle Control Apparatus and Method Thereof

(71) Applicants: Hyundai Motor Company, Seoul (KR); Kia Corporation, Seoul (KR)

(72) Inventors: Mu Gwan Jeong, Hwaseong-si (KR); Nam Gyun KIM, Hwaseong-si (KR); Jae In Lee, Hwaseong-si (KR)

(21) Appl. No.: 19/038,813

(22) Filed: Jan. 28, 2025

(30) Foreign Application Priority Data
Aug. 2, 2024 (KR) 10-2024-0103378

(51) Int. Cl. B60W 60/00

(52) U.S. Cl. CPC B60W 60/001; B60W 2420/408

(57) ABSTRACT

An apparatus for controlling driving of a vehicle may comprise a memory storing a neural network model, and a processor. The processor is configured to, based on inputting a point cloud to the neural network model, form a plurality of grids in a region of interest to map points of the point cloud to a grid map. Based on identifying a position to which the vehicle is predicted to move among the grids and identifying grids in the grid map, the processor generates points using at least one point within the grids, wherein the grids are adjacent to virtual points, and the virtual points correspond to the position. Using the points and an algorithm, and based on a parameter to correct heights of target points indicating a designated type, the processor generates a profile with corrected heights, outputs a signal based on the profile, and controls driving of the vehicle.

### CROSS-REFERENCE TO RELATED APPLICATION

This application claims the benefit of priority to Korean Patent Application No. 10-2024-0103378, filed in the Korean Intellectual Property Office on Aug. 2, 2024, the entire contents of which are incorporated herein by reference.

### TECHNICAL FIELD

The present disclosure relates to a vehicle control apparatus and a method thereof, and more particularly, relates to technologies for generating a profile using light detection and ranging (LiDAR).

### BACKGROUND

The matters described in this Background section are only for enhancement of understanding of the background of the disclosure, and should not be taken as acknowledgment that they correspond to prior art already known to those skilled in the art.

Various studies for identifying an external object using various sensors are being done to assist with driving of a vehicle.

Particularly, while the vehicle is operating in a driving assist mode or an autonomous driving mode, the external object may be identified using a sensor (e.g., LiDAR).

Objects, such as a position to which the vehicle will move, that is, a road surface and/or a rod, among the external objects may be influenced by a behavior of the vehicle. Various studies for generating a profile accurately representing the position are being conducted.

### SUMMARY

The present disclosure has been made to solve the above-mentioned problems occurring in the prior art while advantages achieved by the prior art are maintained intact.

According to the present disclosure, an apparatus for controlling driving of a vehicle, the apparatus may comprise, a sensor configured to obtain a point cloud, a memory storing a neural network model, and a processor, wherein the processor is configured to, based on inputting the point cloud to the neural network model, form a plurality of grids in a region of interest (ROI) to map points of the point cloud to a grid map, based on identifying a position to which the vehicle is predicted to move among the plurality of grids and identifying grids in the grid map, generate representative points by using at least one point within the grids, wherein the grids are adjacent to virtual points, and wherein the virtual points correspond to the position, using the representative points and a designated algorithm and based on obtaining a parameter to correct heights of target points indicating a designated type, generate a profile with corrected heights of the target points, wherein the target points are within the ROI among the at least one point, output, based on the profile, a signal, and control, based on the signal, driving of the vehicle.

The processor is configured to, based on an average value of x-coordinate values of each of the at least one point, an average value of y-coordinate values of each of the at least one point, and an average value of z-coordinate values of each of the at least one point, determine the representative points.

The designated type may comprise a road type, and wherein the road type may comprise at least one of a ground, a crosswalk, or a parking area.

The processor is configured to, determine, based on a designated interval, the at least one point.

The processor is configured to, determine, based on a speed of the vehicle and a scan period of the sensor, the designated interval.

The processor is configured to, determine, based on driving data of the vehicle, a reliability value for the representative points.

The processor is configured to, determine, based on types of the at least one point, the reliability value.

The designated algorithm may comprise at least one of an interpolation algorithm, principle component analysis (PCA), or a rotation transformation algorithm, and wherein the processor is configured to, apply the designated algorithm to the at least one point to obtain the parameter.

The processor is configured to, repeatedly apply the designated algorithm to exclude an outlier.

The processor is configured to, identify, based on points to which movement of wheels included in the vehicle is predicted, the position.

According to the present disclosure, a method performed by an apparatus for controlling driving of a vehicle, the method may comprise, based on inputting a point cloud obtained by a sensor of the apparatus to a neural network model, forming a plurality of grids in a region of interest (ROI) to map points of the point cloud to a grid map, based on identifying a position to which the vehicle is predicted to move among the plurality of grids and identifying grids in the grid map, generating representative points by using at least one point within the grids, wherein the grids are adjacent to virtual points, and wherein the virtual points correspond to the position, and using the representative points and a designated algorithm and based on obtaining a parameter to correct heights of target points indicating a designated type, generating a profile with corrected heights of the target points, wherein the target points are within the ROI among the at least one point, outputting, based on the profile, a signal, and controlling, based on the signal, driving of the vehicle.

The method may further comprise, based on an average value of x-coordinate values of each of the at least one point, an average value of y-coordinate values of each of the at least one point, and an average value of z-coordinate values of each of the at least one point, determining the representative points.

The designated type may comprise a road type, and wherein the road type may comprise at least one of a ground, a crosswalk, or a parking area.

The method may further comprise, determining, based on a designated interval, the at least one point.

The method may further comprise determining, based on a speed of the vehicle and a scan period of the sensor, the designated interval.

The method may further comprise, determining, based on driving data of the vehicle, a reliability value for the representative points.

The method may further comprise, determining, based on types of the at least one point, the reliability value.

The designated algorithm may comprise at least one of an interpolation algorithm, principle component analysis (PCA), or a rotation transformation algorithm, wherein the method may further comprise, applying the designated algorithm to the at least one point to obtain the parameter.

The method may further comprise repeatedly applying the designated algorithm to exclude an outlier.

The method may further comprise identifying, based on points to which movement of wheels included in the vehicle is predicted, the position.

### BRIEF DESCRIPTION OF THE DRAWINGS

The above and other objects, features and advantages of the present disclosure will be more apparent from the following detailed description taken in conjunction with the accompanying drawings:

FIG. 1 shows an example of a block diagram associated with a vehicle control apparatus according to an example of the present disclosure;

FIG. 2 shows an example of generating a virtual point, in an example of the present disclosure;

FIG. 3 shows an example of determining representative points, in an example of the present disclosure;

FIG. 4 shows an example of a flowchart associated with a vehicle control method according to an example of the present disclosure;

FIG. 5 shows an example of generating a profile, in an example of the present disclosure;

FIG. 6 shows an example of a profile, in an example of the present disclosure;

FIG. 7 shows an example of a flowchart associated with a vehicle control method according to an example of the present disclosure; and

FIG. 8 shows an example of a computing system associated with a vehicle control apparatus or a vehicle control method according to an example of the present disclosure.

### DETAILED DESCRIPTION

Hereinafter, some examples of the present disclosure will be described in detail with reference to the exemplary drawings. In adding the reference numerals to the components of each drawing, it should be noted that the identical component is designated by the identical numerals even when they are displayed on other drawings. In addition, a detailed description of well-known features or functions will be ruled out in order not to unnecessarily obscure the gist of the present disclosure.

In describing components of examples of the present disclosure, the terms first, second, A, B, (a), (b), and the like may be used herein. These terms are only used to distinguish one component from another component, but do not limit the corresponding components irrespective of the order or priority of the corresponding components. Furthermore, unless otherwise defined, all terms including technical and scientific terms used herein have the same meaning as being generally understood by those skilled in the art to which the present disclosure pertains. Such terms as those defined in a generally used dictionary are to be interpreted as having meanings equal to the contextual meanings in the relevant field of art, and are not to be interpreted as having ideal or excessively formal meanings unless clearly defined as having such in the present application.

For purposes of this application and the claims, using the exemplary phrase “at least one of: A; B; or C” or “at least one of A, B, or C,” the phrase means “at least one A, or at least one B, or at least one C, or any combination of at least one A, at least one B, and at least one C. Further, exemplary phrases, such as “A, B, and C”, “A, B, or C”, “at least one of A, B, and C”, “at least one of A, B, or C”, etc. as used herein may mean each listed item or all possible combinations of the listed items. For example, “at least one of A or B” may refer to (1) at least one A; (2) at least one B; or (3) at least one A and at least one B.

An automation level of an autonomous driving vehicle may be classified as follows, according to the American Society of Automotive Engineers (SAE). At autonomous driving level 0, the SAE classification standard may correspond to “no automation,” in which an autonomous driving system is temporarily involved in emergency situations (e.g., automatic emergency braking) and/or provides warnings only (e.g., blind spot warning, lane departure warning, etc.), and a driver is expected to operate the vehicle. At autonomous driving level 1, the SAE classification standard may correspond to “driver assistance,” in which the system performs some driving functions (e.g., steering, acceleration, brake, lane centering, adaptive cruise control, etc.) while the driver operates the vehicle in a normal operation section, and the driver is expected to determine an operation state and/or timing of the system, perform other driving functions, and cope with (e.g., resolve) emergency situations. At autonomous driving level 2, the SAE classification standard may correspond to “partial automation,” in which the system performs steering, acceleration, and/or braking under the supervision of the driver, and the driver is expected to determine an operation state and/or timing of the system, perform other driving functions, and cope with (e.g., resolve) emergency situations. At autonomous driving level 3, the SAE classification standard may correspond to “conditional automation,” in which the system drives the vehicle (e.g., performs driving functions such as steering, acceleration, and/or braking) under limited conditions but transfer driving control to the driver when the required conditions are not met, and the driver is expected to determine an operation state and/or timing of the system, and take over control in emergency situations but do not otherwise operate the vehicle (e.g., steer, accelerate, and/or brake). At autonomous driving level 4, the SAE classification standard may correspond to “high automation,” in which the system performs all driving functions, and the driver is expected to take control of the vehicle only in emergency situations. At autonomous driving level 5, the SAE classification standard may correspond to “full automation,” in which the system performs full driving functions without any aid from the driver including in emergency situations, and the driver is not expected to perform any driving functions other than determining the operating state of the system. Although the present disclosure may apply the SAE classification standard for autonomous driving classification, other classification methods and/or algorithms may be used in one or more configurations described herein.

One or more features associated with autonomous driving control may be activated based on configured autonomous driving control setting(s) (e.g., based on at least one of: an autonomous driving classification, a selection of an autonomous driving level for a vehicle, etc.). Based on one or more features (e.g., features of a profile with corrected heights of target points) described herein, an operation of the vehicle may be controlled. The vehicle control may include various operational controls associated with the vehicle (e.g., autonomous driving control, sensor control, braking control, braking time control, acceleration control, acceleration change rate control, alarm timing control, forward collision warning time control, etc.).

One or more auxiliary devices (e.g., engine brake, exhaust brake, hydraulic retarder, electric retarder, regenerative brake, etc.) may also be controlled, for example, based on one or more features (e.g., features of a profile with corrected heights of target points) described herein.

One or more communication devices (e.g., a modem, a network adapter, a radio transceiver, an antenna, etc., that is capable of communicating via one or more wired or wireless communication protocols, such as Ethernet, Wi-Fi, near-field communication (NFC), Bluetooth, Long-Term Evolution (LTE), 5G New Radio (NR), vehicle-to-everything (V2X), etc.) may also be controlled, for example, based on one or more features (e.g., features of a profile with corrected heights of target points) described herein.

Minimum risk maneuver (MRM) operation(s) may also be controlled, for example, based on one or more features (e.g., features of a profile with corrected heights of target points) described herein. A minimal risk maneuvering operation (e.g., a minimal risk maneuver, a minimum risk maneuver) may be a maneuvering operation of a vehicle to minimize (e.g., reduce) a risk of collision with surrounding vehicles in order to reach a lowered (e.g., minimum) risk state. A minimal risk maneuver may be an operation that may be activated during autonomous driving of the vehicle when a driver is unable to respond to a request to intervene. During the minimal risk maneuver, one or more processors of the vehicle may control a driving operation of the vehicle for a set period of time.

Biased driving operation(s) may also be controlled, for example, based on one or more features (e.g., features of a profile with corrected heights of target points) described herein. A driving control apparatus may perform a biased driving control. To perform a biased driving, the driving control apparatus may control the vehicle to drive in a lane by maintaining a lateral distance between the position of the center of the vehicle and the center of the lane. For example, the driving control apparatus may control the vehicle to stay in the lane but not in the center of the lane. The driving control apparatus may identify or determine a biased target lateral distance for biased driving control. For example, a biased target lateral distance may comprise an intentionally adjusted lateral distance that a vehicle may aim to maintain from a reference point, such as the center of a lane or another vehicle, during maneuvers such as lane changes. This adjustment may be made to improve the vehicle's stability, safety, and/or performance under varying driving conditions, etc. For example, during a lane change, the driving control system may bias the lateral distance to keep a safer gap from adjacent vehicles, considering factors such as the vehicle's speed, road conditions, and/or the presence of obstacles, etc.

One or more sensors (e.g., IMU sensors, camera, LIDAR, RADAR, blind spot monitoring sensor, line departure warning sensor, parking sensor, light sensor, rain sensor, traction control sensor, anti-lock braking system sensor, tire pressure monitoring sensor, seatbelt sensor, airbag sensor, fuel sensor, emission sensor, throttle position sensor, inverter, converter, motor controller, power distribution unit, high-voltage wiring and connectors, auxiliary power modules, charging interface, etc.) may also be controlled, for example, based on one or more features (e.g., features of a profile with corrected heights of target points) described herein. An operation control for autonomous driving of the vehicle may include various driving control of the vehicle by the vehicle control device (e.g., acceleration, deceleration, steering control, gear shifting control, braking system control, traction control, stability control, cruise control, lane keeping assist control, collision avoidance system control, emergency brake assistance control, traffic sign recognition control, adaptive headlight control, etc.).

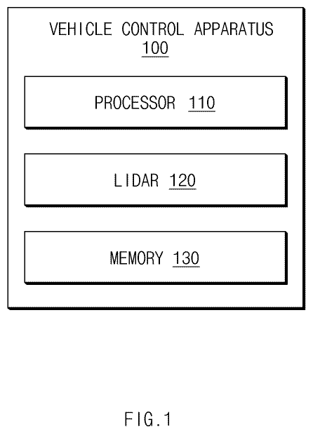

Hereinafter, examples of the present disclosure will be described in detail with reference to FIGS. 1 to 8.

FIG. 1 shows an example of a block diagram associated with a vehicle control apparatus according to an example of the present disclosure.

Referring to FIG. 1, a vehicle control apparatus 100 according to an example of the present disclosure may be implemented inside or outside a vehicle, and some of the components included in the vehicle control apparatus 100 may be implemented inside or outside the vehicle. In this case, the vehicle control apparatus 100 may be integrally configured with control units in the vehicle or may be implemented as a separate device to be connected with the control units of the vehicle by a separate connection means. For example, the vehicle control apparatus 100 may further include components which are not shown in FIG. 1.

The vehicle control apparatus 100 according to an example may include a processor 110, light detection and ranging (LiDAR) 120, and a memory 130. The processor 110, the LiDAR 120, and the memory 130 may be electronically or operably coupled with each other by an electronical component including a communication bus.

Hereinafter, that pieces of hardware are operably coupled with each other may include that a direct connection or an indirect connection between the pieces of hardware is established wired or wirelessly, such that second hardware is controlled by first hardware among the pieces of hardware.

The different blocks are shown, but an example is not limited thereto. Some of the pieces of hardware of FIG. 1 may be included in a single integrated circuit including a system on a chip (SoC). Types of the pieces of hardware included in the vehicle control apparatus 100 and/or the number of the pieces of hardware are/is not limited to those shown in FIG. 1. For example, the vehicle control apparatus 100 may include only some of the pieces of hardware shown in FIG. 1.

The vehicle control apparatus 100 according to an example may include hardware for processing data based on one or more instructions. The hardware for processing the data may include the processor 110.

For example, the hardware for processing the data may include an arithmetic and logic unit (ALU), a floating point unit (FPU), a field programmable gate array (FPGA), a central processing unit (CPU), and/or an application processor (AP). The processor 110 may have a structure of a single-core processor or may have a structure of a multi-core processor including a dual core, a quad core, a hexa core, or an octa core.

According to an example, the vehicle control apparatus 100 may obtain points for representing an external object. For example, the vehicle control apparatus 100 may obtain the points for representing the external object, based on light reflected from the external object.

For example, the LiDAR 120 of the vehicle control apparatus 100 may obtain datasets for identifying a surrounding thing around the vehicle control apparatus 100 (or a vehicle including the vehicle control apparatus 100). For example, the LiDAR 120 may identify at least one of a position of the surrounding thing, a motion direction of the surrounding thing, or a speed of the surrounding thing, or any combination thereof, based on that a pulse laser signal radiated from the LiDAR 120 is reflected from the surrounding thing to return.

The memory 130 of the vehicle control apparatus 100 according to an example may include a hardware component for storing data and/or an instruction input and/or output by the processor 110 of the vehicle control apparatus 100.

For example, the memory 130 may include a volatile memory including a random-access memory (RAM) and/or a non-volatile memory including a read-only memory (ROM).

For example, the volatile memory may include at least one of a dynamic RAM (DRAM), a static RAM (SRAM), a cache RAM, or a pseudo SRAM (PSRAM), or any combination thereof.

For example, the non-volatile memory may include at least one of a programmable ROM (PROM), an erasable PROM (EPROM), an electrically erasable PROM (EEPROM), a flash memory, a hard disk, a compact disc, a solid state drive (SSD), or an embedded multi-media card (eMMC), or any combination thereof.

For example, the memory 130 may include a neural network model. For example, the memory 130 may store the neural network model. For example, the neural network model may include a model for receiving a point cloud and performing semantic segmentation. For example, the neural network model may be referred to as point cloud semantic segmentation (PCSS).

The processor 110 of the vehicle control apparatus 100 according to example may obtain a point cloud by the LiDAR 120. For example, the point cloud may include a set of a plurality of points obtained by the LiDAR 120.

For example, the processor 110 may input the point cloud obtained by the LiDAR 120 to the neural network model stored in the memory 130. For example, the processor 110 may form a plurality of grids in a region of interest (ROI) to map points included in at least a portion of the point cloud obtained by the LiDAR 120 to a grid map, based on inputting the point cloud to the neural network model.

For example, the processor 110 may map points classified into a designated type to the grid map. For example, the designated type may include a type indicating a road. For example, the type indicating the road may include at least one of the road, a crosswalk, a parking area, or the ground, or any combination thereof. However, an example of the present disclosure is not limited to those described above.

For example, the processor 110 may identify a position to which the vehicle will move. For example, the processor 110 may identify the position to which the vehicle will move, based on driving data of the vehicle. For example, the processor 110 may identify the position to which the vehicle will move, based on at least one of a speed of the vehicle or a movement direction of the vehicle, or any combination thereof.

For example, the processor 110 may identify the position to which the vehicle will move, based on a direction in which the vehicle will move, based on a steering sensor. For example, the position to which the vehicle will move may include a position to which each of wheels included in the vehicle will move.

For example, the processor 110 may identify the position to which the vehicle will move, based on points to which the it is predicted that the wheels included in the vehicle will move.

In an example, the processor 110 may identify the position to which the vehicle will move to identify a virtual point corresponding to the position to which the vehicle will move among the plurality of grids. For example, the processor 110 may identify the position to which the vehicle will move to identify grids respectively adjacent to the virtual points corresponding to the position to which the vehicle will move among the plurality of grids in the grid map.

For example, the processor 110 may generate representative points by using at least some points present in the grids respectively adjacent to the virtual points corresponding to the position to which the vehicle will move among the plurality of grids among the points included in the point cloud, based on identifying the position to which the vehicle will move to identify the grids in the grid map.

For example, the processor 110 may determine the at least some points, based on a designated interval. For example, the processor 110 may determine the designated interval, based on at least one of a speed of the vehicle or a scan period of the LiDAR 120, or any combination thereof. For example, the interval between points may be determined based on the following equation: interval=vehicle speed x sensor scan period. For example, the processor 110 may determine the designated interval based on the speed of the vehicle and the scan period of the LiDAR 120 to determine the at least some points.

For example, the processor 110 may identify a coordinate value of each of the at least some points. For example, the processor 110 may identify at least one of an x-coordinate of each of the at least some points, a y-coordinate of each of the at least some points, or a z-coordinate of each of the at least some points, or any combination thereof.

For example, the processor 110 may generate representative points, based on the coordinate value of each of the at least some points. For example, the processor 110 may generate the representative points, based on the at least one of the x-coordinate of each of the at least some points, the y-coordinate of each of the at least some points, or the z-coordinate of each of the at least some points, or the any combination thereof.

For example, the processor 110 may determine the x-coordinate of each of the representative points, based on an average value of the x-coordinate of each of the at least some points. For example, the processor 110 may determine the y-coordinate of each of the representative points, based on an average value of the y-coordinate of each of the at least some points. For example, the processor 110 may determine the z-coordinate of each of the representative points, based on an average value of the z-coordinate of each of the at least some points. For example, the processor 110 may determine the representative points, based on an average value of an x-coordinate value, a y-coordinate value, and a z-coordinate value of each of the at least some points.

In an example, the processor 110 may obtain a parameter for correcting heights of target points indicating the designated type, which are present in the ROI among the at least some points, by using the representative points and a designated algorithm. For example, the designated algorithm may include at least one of an interpolation algorithm or principle component analysis (PCA), or any combination thereof.

For example, the processor 110 may generate a profile by correcting the heights of the target points indicating the designated type, which are present in the ROI among the at least some points, based on obtaining the parameter for correcting the heights of target points, by using the representative point and the designated algorithm.

For example, the processor 110 may output the generated profile, based on generating the profile by generating the heights of the target points. For example, the processor 110 may control driving of the vehicle, using the profile.

As described above, the processor 110 of the vehicle control apparatus 100 may assist with stable driving of the vehicle, by using the profile in which the heights of the target points are corrected for driving of the vehicle.

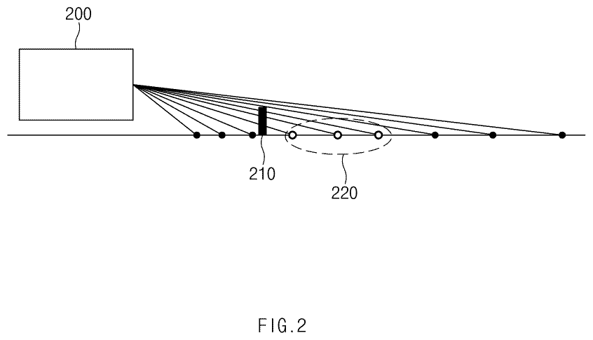

FIG. 2 shows an example of generating a virtual point, in an example of the present disclosure. A virtual point may be used to approximate missing or incomplete data in a grid-based map, for example, when real sensor data, such as LiDAR, is unavailable due to obstacles, occlusions, or sparse measurements. The virtual point may be created by interpolating or averaging coordinates of surrounding real points to maintain continuity in the map. Virtual points may be used for identifying grids adjacent to a vehicle's predicted movement path, enabling accurate calculations of representative points and road profile generation. By compensating for gaps in data, virtual points help ensure reliable detection of road conditions and smooth system operation, even in challenging environments.

Referring to FIG. 2, a processor (e.g., a processor 110 of FIG. 1) of a vehicle control apparatus (e.g., a vehicle control apparatus 100 of FIG. 1) according to an example may obtain a plurality of points, based on a pulse laser signal reflected from the ground, by LiDAR 200.

However, if the processor obtains the plurality of points, there may occur a case in which the processor does not obtain points 220 corresponding to the ground due to an obstacle 210. Thus, the processor may generate more points to overcome it. For example, based on obtaining a point corresponding to the ground at a position close to the vehicle, the processor may generate virtual points around the obtained point. For example, the processor may generate a relatively large number of virtual points at a starting point of a profile.

For example, based on obtaining a point corresponding to the ground at a position away from the vehicle, the processor may generate virtual points around the obtained point. For example, the processor may generate a relatively large number of virtual points at an end point of the profile.

For example, the processor may generate a profile representing a height of a position to which the vehicle will move, based on the generated virtual points and at least some of the plurality of points obtained by the LiDAR 200.

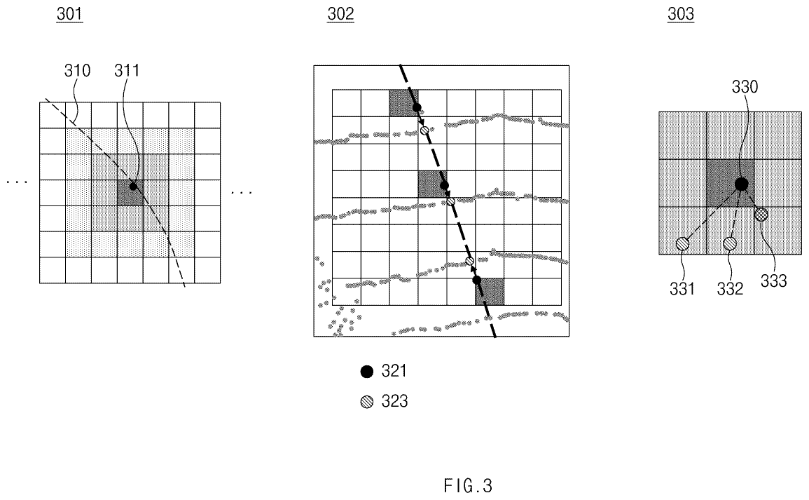

FIG. 3 shows an example of determining representative points, in an example of the present disclosure.

Referring to FIG. 3, a processor (e.g., a processor 110 of FIG. 1) of a vehicle control apparatus (e.g., a vehicle control apparatus 100 of FIG. 1) according to an example may determine a representative point in a grid.

Referring to a first example 301 of FIG. 3, the processor may predict a path 310 along which a vehicle will move. For example, the path 310 may include positions to which wheels of the vehicle will move.

For example, the processor may identify a point 311 indicating a road type, in the path 310. For example, the processor may identify the point 311 indicating the road type in a designated region. For example, while expanding the designated region, the processor may identify the point 311 indicating the road type.

Referring to a second example 302 of FIG. 3, the processor may identify actual points 321. For example, the actual points 321 may include points obtained by LiDAR. For example, the processor may generate virtual points 323, based on the actual points 321. For example, the virtual points 323 may include at least some of the actual points 321 or may include points generated by the processor. Contents associated with the virtual points 323 will be described below with reference to a third example 303.

Referring to the third example 303, the processor may obtain (or generate) a virtual point 330, based on a plurality of points 331, 332, and 333.

For example, the processor may identify the plurality of points 331, 332, and 333 obtained by the LiDAR. The processor may identify each of coordinate values of the plurality of points 331, 332, and 333. For example, the processor may identify at least one of an x-coordinate of each of the plurality of points 331, 332, and 333, a y-coordinate of each of the plurality of points 331, 332, and 333, or a z-coordinate of each of the plurality of points 331, 332, and 333, or any combination thereof.

For example, the processor may identify an average of the x-coordinate of each of the plurality of points 331, 332, and 333. The processor may identify an average of the y-coordinate of each of the plurality of points 331, 332, and 333. The processor may identify an average of the z-coordinate of each of the plurality of points 331, 332, and 333. For example, for each of a plurality of point-1 (1.0, 2.0, 3.0), point-2 (2.0, 3.0, 4.0), and point-3 (3.0, 4.0, 5.0), an average x-coordinate, an average y-coordinate, and an average z-coordinate would be respectively (1.0+2.0+3.0)/3=2.0, (2.0+3.0+4.0)/3=3.0, (3.0+4.0+5.0)/3=4.0.

For example, the processor may obtain coordinates of the virtual point 330, based on the obtained averages (e.g., the average of the x-coordinate, the average of the y-coordinate, and/or the average of the z-coordinate). For example, the processor may generate the virtual points 330, based on the obtained coordinate value of the virtual point 330.

In an example, the processor may identify a point closest to the virtual point 330. For example, the processor may determine the point closest to the virtual point 330 as the representative point 333, based on identifying the point closest to the virtual point 330.

For example, the processor may generate a profile by correcting a height of a position to which the vehicle will move, using the determined representative point 333.

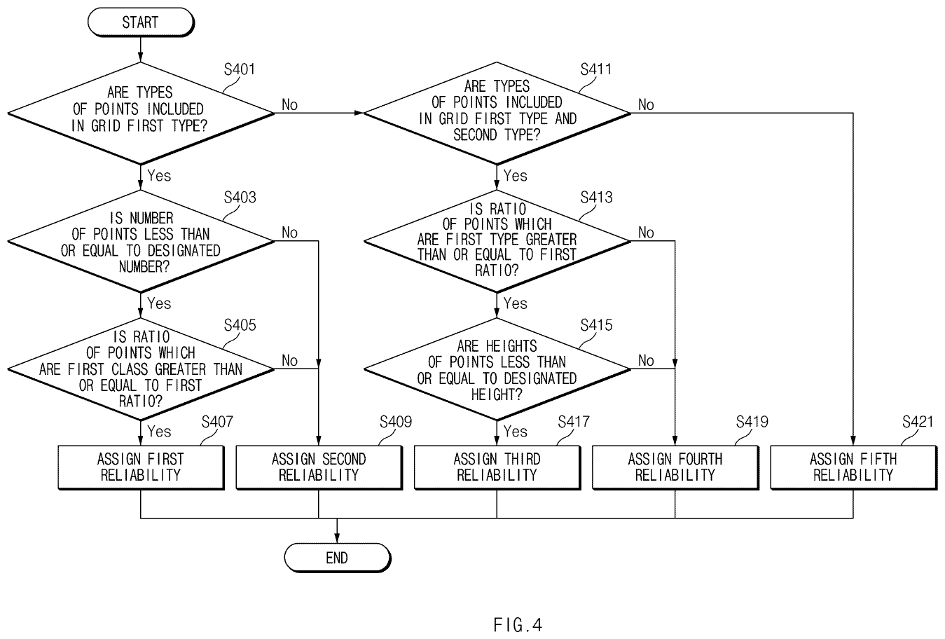

FIG. 4 shows an example of a flowchart associated with a vehicle control method according to an example of the present disclosure. For convenience, FIG. 4 may be described by way of an example in which the steps are performed by a processor (e.g., a vehicle control apparatus). One, some, or all steps of FIG. 4, or portions thereof, may be performed by one or more other circuits. One or some, steps of FIG. 4 may be omitted, performed in other orders, and/or otherwise modified, and/or one or more additional steps may be added.

Hereinafter, it is assumed that a vehicle control apparatus 100 of FIG. 1 performs a process of FIG. 4. Furthermore, in a description of FIG. 4, an operation described as being performed by an apparatus may be understood as being controlled by a processor 110 of the vehicle control apparatus 100.

At least one of the operations of FIG. 4 may be performed by the vehicle control apparatus 100 of FIG. 1. At least one of the operations of FIG. 4 may be controlled by the processor 110 of FIG. 1. The respective operations of FIG. 4 may be sequentially performed, but are not necessarily sequentially performed. For example, an order of the respective operations may be changed, and at least two operations may be performed in parallel.

The operations of FIG. 4 may include operations for assigning reliability to a grid. The assigning reliability (e.g., reliability scoring) may be used to assign confidence levels to grids in a grid-based map to evaluate the quality of the data within each grid. The reliability scoring may be based on factors such as the type of points (e.g., road or non-road), the number of points in the grid, or the consistency of height values (z-coordinates). Grids with a higher proportion of road-type points, sufficient point density, and consistent height values may be assigned higher reliability scores. Conversely, grids with sparse or mixed-type points, or inconsistent height data, may receive lower scores. This process may help prioritize reliable data for generating accurate road profiles and filtering out unreliable or noisy grids. By incorporating reliability scoring, the vehicle control apparatus may ensure robust road detection and improve the stability of vehicle control, especially in challenging environments.

Referring to FIG. 4, in S401, the vehicle control method according to an example may include identifying whether types of points included in the grid are a first type.

For example, the first type may include a type indicating a road.

If the types of the points included in the grid are the first type (Yes in S401), in S403, the vehicle control method according to an example may include identifying whether the number of the points is less than or equal to a designated number.

For example, the vehicle control method may include identifying whether the number of the points present in the grid is less than or equal to the designated number, based on that all the points included in the grid are identified as the first type.

For example, the designated number may include about 8.

If the number of the points is less than or equal to the designated number (Yes in S403), in S405, the vehicle control method according to an example may include identifying whether a ratio of points which are a first class is greater than or equal to a first ratio. For example, the first ratio may include about 75%. For example, the first class may include a road class.

If the ratio of the points which are the first class is greater than or equal to the first ratio (Yes in S405), in S407, the vehicle control method according to an example may include assigning first reliability.

For example, the first reliability may include reliability higher than second reliability, third reliability, fourth reliability, and fifth reliability, which will be described below. For example, the first reliability may include about 15.

For example, the vehicle control method may include assigning the first reliability to a grid in which the ratio of the points which are the first class is greater than or equal to the first ratio.

If the number of the points is not less than or equal to the designated number (No in S403) or the ratio of the points which are the first class is not greater than or equal to the first ratio (No in S405), in S409, the vehicle control method according to an example may include assigning the second reliability.

For example, the second reliability may include reliability which is lower than the first reliability and is higher than the third reliability, the fourth reliability, and the fifth reliability. For example, the second reliability may include about 11.

For example, the vehicle control method may include assigning the second reliability to a grid in which the number of the points is not less than or equal to the designated number or the ratio of the points which are the first class is not greater than or equal to the first ratio.

If the types of the points included in the grid are not the first type (No in S401), in S411, the vehicle control method according to an example may include identifying whether the types of the points included in the grid are the first type and a second type.

For example, the second type may include all of types different from the first type.

If the types of the points included in the grid are the first type and the second type (Yes in S411), in S413, the vehicle control method according to an example may include identifying whether a ratio of points which are the first type is greater than or equal to the first ratio.

For example, the first ratio may include about 75%.

If the ratio of the points which are the first type is greater than or equal to the first ratio (Yes in S413), in S415, the vehicle control method according to an example may include identifying whether heights of the points are less than or equal to a designated height.

For example, the vehicle control method may include identifying an average z value of the points. For example, the vehicle control method may include identifying whether a difference between the average z value of the points and a feature z value of the points is less than or equal to a designated length. For example, the designated length may include about 5 centimeters (cm).

For example, the vehicle control method may include identifying whether the heights of the points are less than or equal to the designated height, based on the average z value of the points and the feature z value of the points. For example, the heights of the points may include a distance (or a length) between a surface and a point, which are estimated as the ground.

If the heights of the points are less than or equal to the designated height (Yes in S415), in S417, the vehicle control method according to an example may include assigning the third reliability.

For example, the third reliability may include reliability which is lower than the first reliability and the second reliability and is higher than the fourth reliability and the fifth reliability.

For example, the vehicle control method may include assigning the third reliability to a grid in which the heights of the points are less than or equal to the designated height.

If the ratio of the points which are the first type is not greater than or equal to the first ratio (No in S413) or the heights of the points are not less than or equal to the designated height (No in S415), in S419, the vehicle control method according to an example may include assigning the fourth reliability.

For example, the fourth reliability may include reliability which is lower than the first reliability, the second reliability, and the third reliability and is higher than the fifth reliability.

For example, the vehicle control method may include assigning the fourth reliability to a grid in which the ratio of the points which are the first type is not greater than or equal to the first ratio or the heights of the points are not less than or equal to the designated height.

If the types of the points included in the grid are not the first type and the second type (No in S411), in S421, the vehicle control method according to an example may include assigning the fifth reliability.

For example, if all the types of the points included in the grid are the second type, the vehicle control method may include assigning the fifth reliability. For example, the vehicle control method may include assigning the fifth reliability to a grid in which the types of the points included in the grid are the second type, based on that all the types of the points included in the grid are the second type.

For example, the fifth reliability may include reliability which is lower than the first reliability, the second reliability, the third reliability, and the fourth reliability.

As described above, the vehicle control method may include assigning reliability to each grid. The vehicle control method may include assigning the reliability to each grid to perform pre-processing for correcting a height.

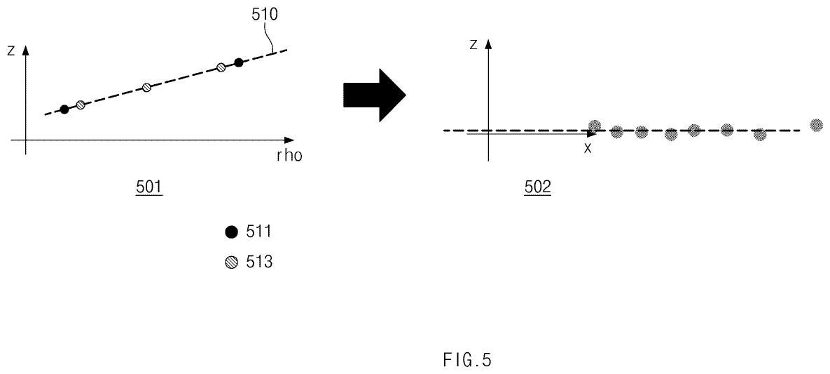

FIG. 5 shows an example of generating a profile, in an example of the present disclosure.

Referring to FIG. 5, a processor (e.g., a processor 110 of FIG. 1) of a vehicle control apparatus (e.g., a vehicle control apparatus 100 of FIG. 1) according to an example may obtain a graph, such as a first example 501, based on generating points for predicting a position to which a vehicle will move.

For example, the graph shown in the first example 501 may include an x-axis indicating an rho value and a z-axis indicating a z value.

For example, first points 511 of the first example 501 may include points obtained by LiDAR (e.g., LiDAR 120 of FIG. 1). For example, the first points 511 may include actual points corresponding to an external object.

For example, second points 513 of the first example 501 may include virtual points generated based on applying a designated algorithm to the first points 511. For example, the second points 513 may include points obtained by adjusting an interval between the first points 511 and correcting heights of the first points 511.

For example, the processor may generate the second points 513, based on a reference line 510 corresponding to the ground. The reference line 510 represented on the graph may correspond to a reference surface of a three-dimensional (3D) virtual coordinate system.

In an example, the processor may apply at least one of z-offset correction or rotation transformation, or any combination thereof to the graph such as the first example 501.

For example, the processor may perform PCA for points corresponding to a designated type (e.g., a road type). The processor may obtain at least one of a straight line equation or a plane equation, or any combination thereof, based on performing the PCA. PCA may be used to analyze and adjust the orientation of spatial data, such as LiDAR points, to account for surface inclinations or slopes. PCA may identify the primary direction (principal components) of the point cloud data within a region of interest by calculating a best-fit line or plane. This line or plane may be derived from the statistical distribution of the x, y, and z coordinates of the points. Once the principal components are determined, the processor may apply transformations, such as z-offset correction or rotation, to align the surface data with a reference plane, correcting for inclinations caused by slopes, bumps, or vehicle pitch.

For example, the processor may repeatedly perform the PCA to remove an outlier to ensure greater accuracy. PCA may enables the generation of stable and precise road profiles, improving a vehicle's ability to detect road features and ensure reliable vehicle control.

In an example, the processor may apply the at least one of the z-offset correction or the rotation transformation, or the any combination thereof to the at least one of the straight line equation or the plane equation, or the any combination thereof, which is obtained based on the PCA, thus obtaining a profile such as a second example 502.

In an example, the processor may use the obtained profile for control of the vehicle, based on obtaining the profile such as the second example 502.

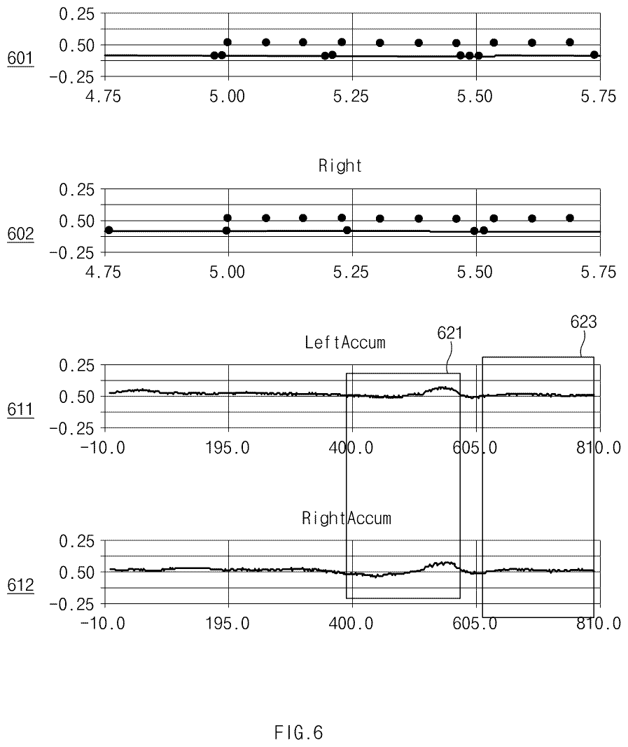

FIG. 6 shows an example of a profile, in an example of the present disclosure.

Referring to FIG. 6, a processor (e.g., a processor 110 of FIG. 1) of a vehicle control apparatus (e.g., a vehicle control apparatus 100 of FIG. 1) according to an example may obtain profiles in which a height is corrected.

A first graph 601 and a second graph 602 of FIG. 6 may include graphs before positions of points are corrected. A third graph 611 and a fourth graph 612 may include profiles generated by correcting positions of points.

For example, the first graph 601 may be a graph including points in which positions to which left wheels of a vehicle will move are predicted. For example, the second graph 602 may be a graph including points in which positions to which right wheels of the vehicle will move are predicted.

For example, the processor of the vehicle control apparatus may obtain the third graph 611 and the fourth graph 612, based on the first graph 601 and the second graph 602.

For example, the third graph 611 may include a graph obtained by correcting the positions to which the left wheels of the vehicle will move. For example, the fourth graph 612 may include a graph obtained by correcting the positions to which the right wheels of the vehicle will move.

For example, in the third graph 611 and the fourth graph 612, a first portion 621 and a second portion 623 may be portions where the positions are corrected. For example, the first portion 621 may include a bump and a position including a starting point of the bump. As a pitch occurs due to deceleration of the vehicle occurs, the first portion 621 may be unstable. However, as the processes of the present disclosure are applied to the first portion 621, the shape of the bump may be clearly output. For example, the second portion 623 may include a rear portion of the bump. The second portion 623 may include an example of correcting the pitch of the vehicle, which is generated by the bump, to generate a more stable profile. Pitch correction for road profiles may be used to adjust for changes in a vehicle's orientation caused by acceleration, deceleration, or uneven terrain, such as bumps. When a vehicle encounters features like speed bumps or dips, its front and rear ends may tilt, causing distortions in the LiDAR data and the perceived road profile. Pitch correction may involve analyzing the vehicle's motion data and applying adjustments to compensate for these tilts, ensuring the road profile reflects the actual surface conditions. This correction may improve the accuracy of features like bump heights and road inclinations in the generated profile. The pitch correction may enable more stable vehicle control and enhance the vehicle control apparatus' reliability in detecting and responding to road conditions.

As described above, the processor of the vehicle control apparatus may perform the process of the present disclosure to generate the profile accurately representing the bump and generate the profile accurately representing the rear region of the bump. By generating the above profile, the processor of the vehicle control apparatus may provide help to stable driving of the vehicle.

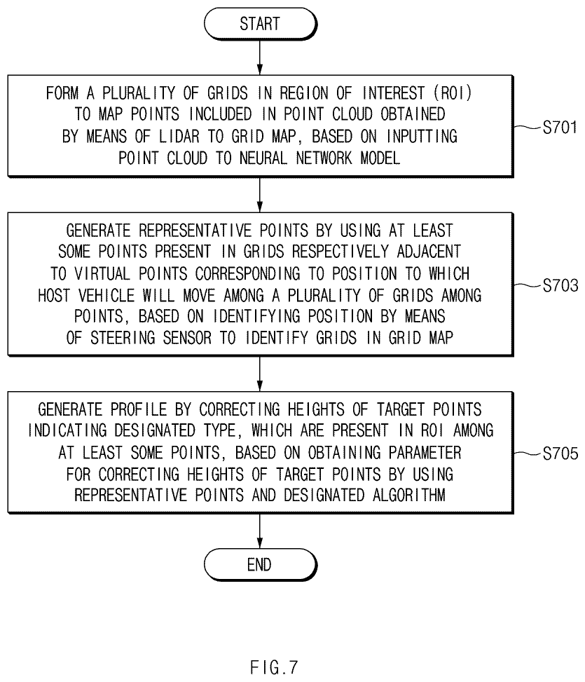

FIG. 7 shows an example of a flowchart associated with a vehicle control method according to an example of the present disclosure. For convenience, FIG. 7 may be described by way of an example in which the steps are performed by a processor (e.g., a vehicle control apparatus). One, some, or all steps of FIG. 7, or portions thereof, may be performed by one or more other circuits. One or some, steps of FIG. 7 may be omitted, performed in other orders, and/or otherwise modified, and/or one or more additional steps may be added.

Hereinafter, it is assumed that a vehicle control apparatus 100 of FIG. 1 performs a process of FIG. 7. Furthermore, in a description of FIG. 7, an operation described as being performed by an apparatus may be understood as being controlled by a processor 110 of the vehicle control apparatus 100.

At least one of the operations of FIG. 7 may be performed by the vehicle control apparatus 100 of FIG. 1. At least one of the operations of FIG. 7 may be controlled by the processor 110 of FIG. 1. The respective operations of FIG. 7 may be sequentially performed, but are not necessarily sequentially performed. For example, an order of the respective operations may be changed, and at least two operations may be performed in parallel.

Referring to FIG. 7, in S701, the vehicle control method according to example may include performing a grid-based mapping by forming a plurality of grids in a region of interest (ROI) to map points included in a point cloud obtained by LiDAR to a grid map, based on inputting the point cloud to a neural network model. For example, a point cloud may comprise a collection of data points in a three-dimensional coordinate system, representing the external surface of an object or environment. Each point in the cloud may have its own set of X, Y, and Z coordinates, and/or additional information (e.g., color or intensity). Point clouds may be generated by 3D scanners, LiDAR, or photogrammetry techniques, and may be used in various applications such as 3D modeling, computer vision, and/or robotics, etc. They may provide a highly detailed and/or accurate representation of complex surfaces and/or structures, making them ideal for tasks like object recognition, environment mapping, and/or digital reconstruction, etc.

For grid-based mapping, the ROI may be divided into a plurality of smaller, uniform grids to organize and analyze spatial data (e.g., LiDAR point cloud information). Each grid may represent a localized area where points detected by LiDAR sensors are mapped. Within each grid, a representative point can be generated by averaging the x, y, and z coordinates of the points in that grid, providing a simplified yet accurate representation of the grid's spatial characteristics. This approach may reduce computational complexity by summarizing dense point cloud data while retaining useful information about the road surface or terrain (e.g., road bumps, uneven surfaces, etc.).

In S703, the vehicle control method according to an example may include generating representative points by using at least some points present in grids respectively adjacent to virtual points corresponding to a position to which a vehicle will move among a plurality of grids among the points, based on identifying the position to identify the grids in the grid map.

For example, the vehicle control method may include determining the representative points, based on an average value of an x-coordinate value, a y-coordinate value, and a z-coordinate value of each of the at least some points.

For example, the vehicle control method may include determining the at least some points, based on a designated interval. For example, the vehicle control method may include determining the designated interval, based on a speed of the vehicle and a scan period of the LiDAR.

For example, the vehicle control method may include identifying the position, based on points to which it is predicted that wheels included in the vehicle will move.

In S705, the vehicle control method according to an example may include generating a profile by correcting heights of target points indicating a designated type, which are present in the ROI among the at least some points, based on obtaining a parameter for correcting the heights of the target points by using the representative points and a designated algorithm.

For example, the designated type may include a road type including at least one of the ground, a crosswalk, or a parking area, or any combination thereof.

For example, the vehicle control method may include identifying reliability for the representative points, based on driving data of the vehicle.

For example, the vehicle control method may include identifying reliability, based on types of the at least some points.

For example, the designated algorithm may include at least one of an interpolation algorithm, PCA, or a rotation transformation algorithm, or any combination thereof.

For example, the vehicle control method may include applying the designated algorithm to at least one point to obtain a parameter.

For example, the vehicle control method may include repeatedly applying the designated algorithm to exclude an outlier.

For example, the vehicle control method may include repeatedly generating the profile and correcting a height of the position, based on accumulating the repeatedly generated profiles.

As described above, the vehicle control method according to an example may include generating the profile by correcting the height. The vehicle control method may provide help to stable driving of the vehicle by generating the profile by correcting the height.

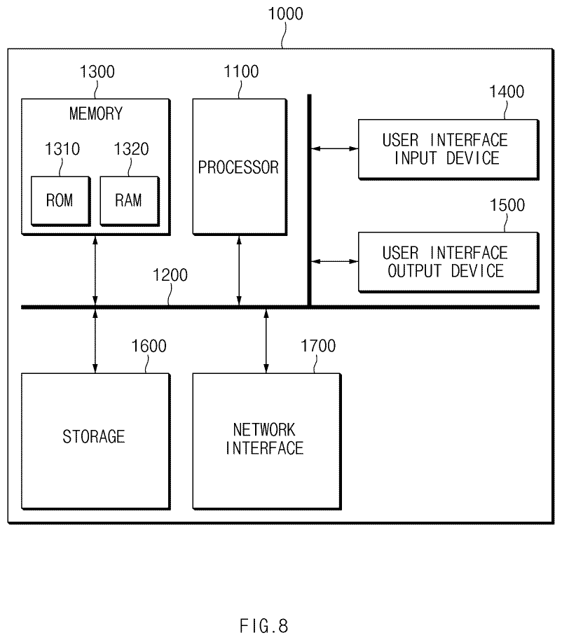

FIG. 8 shows an example of a computing system associated with a vehicle control apparatus or a vehicle control method according to an example of the present disclosure.

Referring to FIG. 8, a computing system 1000 may include at least one processor 1100, a memory 1300, a user interface input device 1400, a user interface output device 1500, a storage 1600, and a network interface 1700, which are connected with each other via a bus 1200.

The processor 1100 may be a central processing unit (CPU) or a semiconductor device that processes instructions stored in the memory 1300 and/or the storage 1600. The memory 1300 and the storage 1600 may include various types of volatile or non-volatile storage media. For example, the memory 1300 may include a read only memory (ROM) 1310 and a random access memory (RAM) 1320.

Accordingly, the operations of the method or algorithm described in connection with the examples disclosed in the specification may be directly implemented with a hardware module, a software module, or a combination of the hardware module and the software module, which is executed by the processor 1100. The software module may reside on a storage medium (that is, the memory 1300 and/or the storage 1600) such as a RAM, a flash memory, a ROM, an EPROM, an EEPROM, a register, a hard disc, a removable disk, and a CD-ROM.

The exemplary storage medium may be coupled to the processor 1100. The processor 1100 may read out information from the storage medium and may write information in the storage medium. Alternatively, the storage medium may be integrated with the processor 1100. The processor and the storage medium may reside in an application specific integrated circuit (ASIC). The ASIC may reside within a user terminal. In another case, the processor and the storage medium may reside in the user terminal as separate components.

An example of the present disclosure provides a vehicle control apparatus for generating a profile accurately representing a behavior of a vehicle and a ground state and a method thereof.

Another example of the present disclosure provides a vehicle control apparatus for performing a process for some points to reduce the amount of calculation and increase a calculation speed and a method thereof.

Another example of the present disclosure provides a vehicle control apparatus for generating a profile accurately representing a ground state in real time in an embedded environment and a method thereof.

The technical problems to be solved by the present disclosure are not limited to the aforementioned problems, and any other technical problems not mentioned herein will be clearly understood from the following description by those skilled in the art to which the present disclosure pertains.

According to an example of the present disclosure, a vehicle control apparatus may include light detection and ranging (LiDAR), a memory storing a neural network model, and a processor. The processor may form a plurality of grids in a region of interest (ROI) to map points included in a point cloud obtained by the LiDAR to a grid map, based on inputting the point cloud to the neural network model, may generate representative points by using at least some points present in grids respectively adjacent to virtual points corresponding to a position to which a vehicle will move among the plurality of grids among the points, based on identifying the position to identify the grids in the grid map, and may generate a profile by correcting heights of target points indicating a designated type, the target points being present in the ROI among the at least some points, based on obtaining a parameter for correcting the heights of the target points, by using the representative points and a designated algorithm.

In an example, the processor may determine the representative points, based on an average value of an x-coordinate value, a y-coordinate value, and a z-coordinate value of each of the at least some points.

In an example, the designated type may include a road type including at least one of the ground, a crosswalk, or a parking area, or any combination thereof.

In an example, the processor may determine the at least some points, based on a designated interval.

In an example, the processor may determine the designated interval, based on a speed of the vehicle and a scan period of the LiDAR.

In an example, the processor may determine reliability for the representative points, based on driving data of the vehicle.

In an example, the processor may determine the reliability, based on types of the at least some points.

In an example, the designated algorithm may include at least one of an interpolation algorithm, principle component analysis (PCA), or a rotation transformation algorithm, or any combination thereof. In an example, the processor may apply the designated algorithm to the at least some points to obtain the parameter.

In an example, the processor may repeatedly apply the designated algorithm to exclude an outlier.

In an example, the processor may identify the position, based on points to which it is predicted that wheels included in the vehicle will move.

According to another example of the present disclosure, a vehicle control method may include forming, by a processor, a plurality of grids in a region of interest (ROI) to map points included in a point cloud obtained by LiDAR to a grid map, based on inputting the point cloud to a neural network model, generating, by the processor, representative points by using at least some points present in grids respectively adjacent to virtual points corresponding to a position to which a vehicle will move among the plurality of grids among the points, based on identifying the position to identify the grids in the grid map, and generating, by the processor, a profile by correcting heights of target points indicating a designated type, the target points being present in the ROI among the at least some points, based on obtaining a parameter for correcting the heights of the target points, by using the representative points and a designated algorithm.

The vehicle control method according to an example may further include determining the representative points, based on an average value of an x-coordinate value, a y-coordinate value, and a z-coordinate value of each of the at least some points.

In an example, the designated type may include a road type including at least one of the ground, a crosswalk, or a parking area, or any combination thereof.

The vehicle control method according to an example may further include determining the at least some points, based on a designated interval.

The vehicle control method according to an example may further include determining the designated interval, based on a speed of the vehicle and a scan period of the LiDAR.

The vehicle control method according to an example may further include identifying reliability for the representative points, based on driving data of the vehicle.

The vehicle control method according to an example may further include determining the reliability, based on types of the at least some points.

In an example, the designated algorithm may include at least one of an interpolation algorithm, principle component analysis (PCA), or a rotation transformation algorithm, or any combination thereof. The vehicle control method may further include applying the designated algorithm to the at least some points to obtain the parameter.

The vehicle control method according to an example may further include repeatedly applying the designated algorithm to exclude an outlier.

The vehicle control method according to an example may further include identifying the position, based on points to which it is predicted that wheels included in the vehicle will move.

The present technology may generate a profile accurately representing a behavior of a vehicle and a ground state.

Furthermore, the present technology may perform a process for some points to reduce the amount of calculation and increase a calculation speed.

Furthermore, the present technology may generate a profile accurately representing a ground state in real time in an embedded environment.

In addition, various effects ascertained directly or indirectly through the present disclosure may be provided.

Hereinabove, although the present disclosure has been described with reference to examples and the accompanying drawings, the present disclosure is not limited thereto, but may be variously modified and altered by those skilled in the art to which the present disclosure pertains without departing from the spirit and scope of the present disclosure claimed in the following claims.

Therefore, the examples disclosed in the present disclosure is not intended to limit the technical idea of the present disclosure and is intended to describe it, and the scope of the technical idea of the present disclosure is not limited by the examples. The scope of the present disclosure should be construed on the basis of the accompanying claims, and all the technical ideas within the scope equivalent to the claims should be interpreted as being included in the claims of the present disclosure.

What is claimed is:

1. An apparatus for controlling driving of a vehicle, the apparatus comprising:
a sensor configured to obtain a point cloud;
a memory storing a neural network model; and
a processor,
wherein the processor is configured to:
based on inputting the point cloud to the neural network model, form a plurality of grids in a region of interest (ROI) to map points of the point cloud to a grid map;
based on identifying a position to which the vehicle is predicted to move among the plurality of grids and identifying grids in the grid map, generate representative points by using at least one point within the grids, wherein the grids are adjacent to virtual points, and wherein the virtual points corresponds to the position;
using the representative points and a designated algorithm and based on obtaining a parameter to correct heights of target points indicating a designated type, generate a profile with corrected heights of the target points, wherein the target points are within the ROI among the at least one point;
output, based on the profile, a signal; and
control, based on the signal, driving of the vehicle.

2. The apparatus of claim 1, wherein the processor is configured to:
based on an average value of x-coordinate values of each of the at least one point, an average value of y-coordinate values of each of the at least one point, and an average value of z-coordinate values of each of the at least one point, determine the representative points.

3. The apparatus of claim 1, wherein the designated type comprises a road type, and wherein the road type comprises at least one of a ground, a crosswalk, or a parking area.

4. The apparatus of claim 1, wherein the processor is configured to:
determine, based on a designated interval, the at least one point.

5. The apparatus of claim 4, wherein the processor is configured to:
determine, based on a speed of the vehicle and a scan period of the sensor, the designated interval.

6. The apparatus of claim 1, wherein the processor is configured to:
determine, based on driving data of the vehicle, a reliability value for the representative points.

7. The apparatus of claim 6, wherein the processor is configured to:
determine, based on types of the at least one point, the reliability value.

8. The apparatus of claim 1, wherein the designated algorithm comprises at least one of an interpolation algorithm, principle component analysis (PCA), or a rotation transformation algorithm, and
wherein the processor is configured to:
apply the designated algorithm to the at least one point to obtain the parameter.

9. The apparatus of claim 8, wherein the processor is configured to:
repeatedly apply the designated algorithm to exclude an outlier.

10. The apparatus of claim 1, wherein the processor is configured to:
identify, based on points to which movement of wheels included in the vehicle is predicted, the position.

11. A method performed by an apparatus for controlling driving of a vehicle, the method comprising:
based on inputting a point cloud obtained by a sensor of the apparatus to a neural network model, forming a plurality of grids in a region of interest (ROI) to map points of the point cloud to a grid map;
based on identifying a position to which the vehicle is predicted to move among the plurality of grids and identifying grids in the grid map, generating representative points by using at least one point within the grids, wherein the grids are adjacent to virtual points, and wherein the virtual points corresponds to the position; and
using the representative points and a designated algorithm and based on obtaining a parameter to correct heights of target points indicating a designated type, generating a profile with corrected heights of the target points, wherein the target points are within the ROI among the at least one point;
outputting, based on the profile, a signal; and
controlling, based on the signal, driving of the vehicle.

12. The method of claim 11, further comprising:
based on an average value of x-coordinate values of each of the at least one point, an average value of y-coordinate values of each of the at least one point, and an average value of z-coordinate values of each of the at least one point, determining the representative points.

13. The method of claim 11, wherein the designated type comprises a road type, and wherein the road type comprises at least one of a ground, a crosswalk, or a parking area.

14. The method of claim 11, further comprising:
determining, based on a designated interval, the at least one point.

15. The method of claim 14, further comprising:
determining, based on a speed of the vehicle and a scan period of the sensor, the designated interval.

16. The method of claim 11, further comprising:
determining, based on driving data of the vehicle, a reliability value for the representative points.

17. The method of claim 16, further comprising:
determining, based on types of the at least one point, the reliability value.

18. The method of claim 11, wherein the designated algorithm comprises at least one of an interpolation algorithm, principle component analysis (PCA), or a rotation transformation algorithm,
wherein the method further comprises:
applying the designated algorithm to the at least one point to obtain the parameter.

19. The method of claim 18, further comprising:
repeatedly applying the designated algorithm to exclude an outlier.

20. The method of claim 11, further comprising:
identifying, based on points to which movement of wheels included in the vehicle is predicted, the position.
